(19) United States
(12) Patent Application Publication
(10) Pub. No.: US 2014/0107816 A1
(43) Pub. Date: Apr. 17, 2014

(54) DYNAMICALLY CREATING FUTURE ROUTES BASED ON USER CHARACTERISTICS

(71) Applicant: QUALCOMM ISKOOT, INC., San Diego, CA (US)

(72) Inventors: Isaac David Guedalia, Bet Shemesh (IL); Sarah Harris-Glickfield, Jerusalem (IL); Brachi Lederman, Bet Shemesh (IL)

(73) Assignee: Qualcomm iSkoot, Inc., San Diego, CA (US)

(21) Appl. No.: 13/652,811

(22) Filed: Oct. 16, 2012

(51) Int. Cl. G06F 19/00

(52) U.S. Cl. 700/91

(57) ABSTRACT

The various embodiments support athletic training by using a series of real-time positions transmitted by an electronic training device to a server to identify a training segment including at least a portion of the series of positions, transmit training information related to the identified training segment to the electronic training device, and display the training information at the electronic training device. In an embodiment, a string of segments from a current location of the electronic device may be identified based on a previous route and training information related to the string of segments may be transmitted to the electronic training device and displayed at the electronic device. In the various embodiments, training information may include information related to the performance of other individuals over a segment and/or string of segments and a navigation indication identifying a direction of a segment and/or string of segments.

### BACKGROUND

Athletes often pace themselves against their best times and performances when walking, running, or biking. This allows athletes to manage their training and track their improvements over time. Athletes also enjoy pacing themselves against others, which provides incentives to train harder and perspectives on their competitiveness. However, such pacing is only possible in the athletes home environment where their times and performance over a given route and terrain have been previously recorded.

Sometimes an athlete, such as a walker, runner, or biker, starts out on one route, but decides to change directions and continue the activity, such as a walk, run, or ride, along a different route. If the athlete is using an electronic distance and/or training monitoring device, the athlete will likely not want to have to reconfigure the electronic distance and/or training monitoring device for the new route.

### SUMMARY

The systems, methods, and devices of the various embodiments support athletic training by using a series of real-time positions transmitted by an electronic training device to a server to identify a training segment including at least a portion of the series of positions, transmit training information related to the identified training segment to the electronic training device, and display the training information at the electronic training device. In an embodiment, a string of segments from a current location of the electronic device may be identified based on a previous route or the user of the electronic device and/or a previous route of another user, and training information related to the string of segments may be transmitted to the electronic training device and displayed at the electronic device. In the various embodiments, training information may include information related to the performance of other individuals over a segment and/or string of segments and a navigation indication identifying a direction of a segment and/or string of segments. The various embodiments provide a system that enables an athlete, such as a walker, runner, or biker to pace him/herself over training routes which he/she has not previously traveled, such as training routs outside his/her home environment. The various embodiments provide a system that can dynamically predict where an athlete is going and allow them to compare their performance over a new route taken with previous performances over previous training routes. The various embodiments provide a system that can identify training routes best suited to the individual athlete based upon that athlete's past training routines, particularly when the individual athlete is out for an activity, such as a walk, run, or ride in an unfamiliar location.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a communications flow diagram of interactions in a communication system suitable for use with the various embodiments.

FIG. 3 is a component and functional block diagram of an electronic training device suitable for use with the various embodiments.

FIG. 4 illustrates an example route according to the various embodiments.

FIGS. 5A-5C are route mapping diagrams illustrating relationships between positions and training segments according to the various embodiments.

FIGS. 6A-6D are route mapping diagrams illustrating relationships between a new position and a string of potential training segments.

FIG. 7 is a data structure diagram illustrating potential elements of a training segment.

FIGS. 8A and 8B are process flow diagrams illustrating embodiment methods for transmitting a series of positions to a server and receiving training route recommendations.

FIG. 9 is a process flow diagram illustrating an embodiment method for transmitting training information related to an identified training segment and/or string of training segments.

FIG. 10 is a process flow diagram illustrating an embodiment method for transmitting training information related to a newly identified string of training segments.

FIG. 11 is a process flow diagram illustrating an embodiment method for transmitting training information related to another individual's training route.

FIG. 12 is a process flow diagram illustrating an embodiment method for identifying a closest matching user route based on clustering.

FIG. 13A is a process flow diagram illustrating an embodiment method for selecting a series of successive segments to approximate a user route.

FIG. 13B is a process flow diagram illustrating an embodiment method for selecting a series of successive segments to approximate a user route based on point by point comparison.

FIG. 14 is a data structure diagram illustrating potential elements of a route segment comparison table.

FIG. 15 is a data structure diagram illustrating potential elements of a route point comparison table.

FIG. 16 is a data structure diagram illustrating potential elements of a training information message.

FIG. 17 is a component diagram of an example electronic training device suitable for use with the various embodiments.

FIG. 18 is a component diagram of another example electronic training device suitable for use with the various embodiments.

FIG. 19 is a component diagram of an example server suitable for use with the various embodiments

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “electronic device,” “training device,” “electronic training device,” “mobile device,” and “receiver device” are used interchangeably herein to refer to any one or all of cellular telephones, smart phones, personal or mobile multimedia players, personal data assistants (PDA's), laptop computers, tablet computers, smart books, palm-top computers, wireless electronic mail receivers, multimedia Internet enabled cellular telephones, athletic training devices, personal position tracking devices, sports watches, and similar personal electronic devices which include a programmable processor and memory and circuitry for determining location and supporting athletic training.

The various embodiments support athletic training by using a series of real-time positions transmitted by an electronic training device to a server which is configured to identify a training segment including at least a portion of the series of positions and transmit training information related to the identified training segment to the electronic training device for display. In an embodiment, a tracking application on an electronic training device, such as a tracking application downloaded to a smart phone or a tracking application resident on a GPS enabled sports watch, may keep track of training information related to a user's walk, run, and/or ride, such as time, pace, distance, positions, etc. The electronic training device may upload the training information about the walk, run, and/or ride to a server in real-time, for example over a data connection conforming to the Hypertext Transport Protocol (“HTTP”), and the server may store the training information in a database available to the server. In an embodiment, the training information stored in the database may be accessible via a website, enabling the user of the electronic training device to review their traveled route as well as additional training information pertaining to their workout (i.e., walk, run, and/or ride). In an embodiment, the server may compare the current training information to the training information stored in the database to identify similar routes, compare user performance information, and provide training information to the electronic training device. In this manner, the server may have access to a larger data store of training information stored in the database and may perform processing on the training information that would be prohibitive if performed by the electronic device itself.

By creating a database of known characteristics of specific routes, the server may be configured to identify paths and routes with characteristics similar to a user's previously traveled (i.e., biked, run, walked, etc.) training routes. The identification of similar routes may enable users to continue to pace themselves while in a different location or following an alternative route. For example, a user may bike ride competitively, but while on vacation the user may have no way of comparing their current performance to their usual performance because they are biking on new routes. In an embodiment, the server may identify bike routes to follow that have similar characteristics in terms of grade and distance to the user's usual training routes. In another embodiment, the server may dynamically predict routes as a user travels. In an embodiment, when a server detects the user has deviated from a suggested route, the server may dynamically and in real time adjust to the change in direction and predict where the user may be heading and propose an alternative training route. In proposing the alternative training route, the server may take into account the user's normal training routines, previous training performances (e.g., times vs. distance and grade) and the training performances of other athletes in order to propose an alternative route consistent with the user's goals and preferences. The server may also transmit training performance objectives (e.g., distances within set times, pace, etc.) commensurate with the alternative training route consistent with the user's condition and normal training routine, and/or the performance of others. This capability enables the user to pick an arbitrary route and randomly change routes while exercising and receive in real time feed back on appropriate training performance to maintain (e.g., pace) commensurate with the selected route to allow the user to enjoy a consistent training experience.

In an embodiment, the electronic training device may be a wireless device, such as a smart phone, running a training application, such as an Android® based training application, on a processor. The electronic training device may include a navigation sensor, such as a Global Positioning System (“GPS”) receiver which may provide position information, such GPS coordinates (e.g., latitude, longitude, altitude), to the processor and training application and/or store the position information in a memory of the electronic training device. In a further embodiment, the electronic training device may compare the present route to previous routes and output information regarding the current route to a display of the electronic training device. As an example, the electronic training device may track the user's route while she/he is riding, driving, or walking and display training information such as current speed, distance covered, and/or a map.

In an embodiment, after the electronic training device has traveled a specific distance, for example a defined segment distance, such as 50 meters, a series of positions may be sent to a server for comparison. In an embodiment, the distance traveled by the electronic training device before sending a series of positions to a server may be different from the defined segment distance. As an example, the electronic training device may send a series of positions to the server after the electronic training device has traveled approximately 50 meters, but the defined segment distance may be approximately 25 meters. As another example, the electronic training device may send a series of positions to the server after the electronic training device has traveled approximately 25 meters, but the defined segment distance may be 50 meters. In an embodiment, the defined segment distance may vary based on the activity. As an example, when the electronic training device is being used on a run, the segment distance may be 50 meters, and when the electronic training device is being used on a ride, the segment distance may be 500 meters. In an embodiment, the server may receive the series of positions and may store the series of positions as a route segment. In an embodiment, a stored route segment may include training information/characteristics related to the segment, such as a starting point's latitude and longitude, an ending point's latitude and longitude, and the latitude and longitude of any intermediate points. The stored route segment may also include training information/characteristics of the segment, such as a length, elevation, grade, etc. Additionally, training information/characteristics related to the segment may also be included, such as a route ID of the route the segment is a portion of, a navigation indication such as a direction (e.g., north, south, etc.) of the segment, a travel date and/or time when the segment was traveled, a speed indicating how fast the segment was traveled, and/or a user ID of the user of the electronic device who traveled the segment.

In an embodiment, the server may identify a previously traveled route and/or segment that is most similar to the current route and/or segment. The server may send training information related to the most similar route and/or segment to the electronic training device, such as segment points latitude and longitude, electronic training device user performance information, segment/route length, segment/route elevation, segment/route grade, segment/route ID, segment/route speed, another individual's performance information, navigation indications (e.g., direction, such as left, right, north, south, etc.) performance target for the user of the electronic device, etc. In an embodiment, the received training information may be displayed on the electronic training device, such as in an overlay of a map, and a comparison of the speed traveled in the past for the last segment may also be displayed. In an embodiment, the received training information may include a navigation indication, such as a direction indication and a display element related to the direction indication, such as a turn arrow, may be displayed identifying a direction of a new string of segments.

In an embodiment, the server may identify a previously traveled route that is similar to a current route by comparing segments of a previously traveled route to the new current route. As an example, the server may assign values to each segment of the previously traveled routes and the current route based on characteristics, such as grade, and may compare the difference between the values of each previously traveled route segment to the values of each current route segment. The server may determine that the previously traveled route with the overall least amount of difference between the values of its respective segments and the segments of the current route is most similar to the new current route.

In an embodiment, the server may identify a previously traveled route that is similar to a current route by comparing individual points of a previously traveled route to the points of a new current route. As an example, the server may compare points of the previously traveled routes to the points of the new current route to determine a difference between the points, such as a distance between the points. The server may sum the difference between the points in each previously traveled route and the new current route to determine a difference total for each previously traveled route, and the server may select the previously traveled route with the lowest difference total as the route that is most similar to the new current route.

In an embodiment, a combination of point comparisons and segment comparisons of previous routes to new current positions may be used by the server to select a string of segments having distance and grade characteristics similar to a training route of a user of the electronic device. In the various embodiments, the previously traveled routes may be previously traveled routes of the user of the electronic device and/or previously traveled routes of one or more other individuals. In an embodiment, the server may identify another individual with similar attributes, such as height, weight, gender, age, experience level, performance goals, etc., to the user of the electronic training device and may select a string of segments having distance and grade characteristics similar to a training route of the other individual sharing a common attribute with the user of the electronic device.

In an embodiment, a string of segments from a current location of the electronic device may be identified based on a previous route of the user of the electronic device and/or a previous route of another user, and training information related to the string of segments may be transmitted to the electronic training device and displayed at the electronic device. In the various embodiments, training information may include information related to the performance of other individuals over a segment and/or string of segments and a navigation indication identifying a direction of a segment and/or string of segments.

In an embodiment, the server may store received series of positions regardless of whether a previously traveled route is determined to be similar to a current route. In this manner, though no similar route may be found during the current workout the server may increase a store of previous routes, and the next time the current route is traveled the server may be able to determine a similar route using the stored received series of positions.

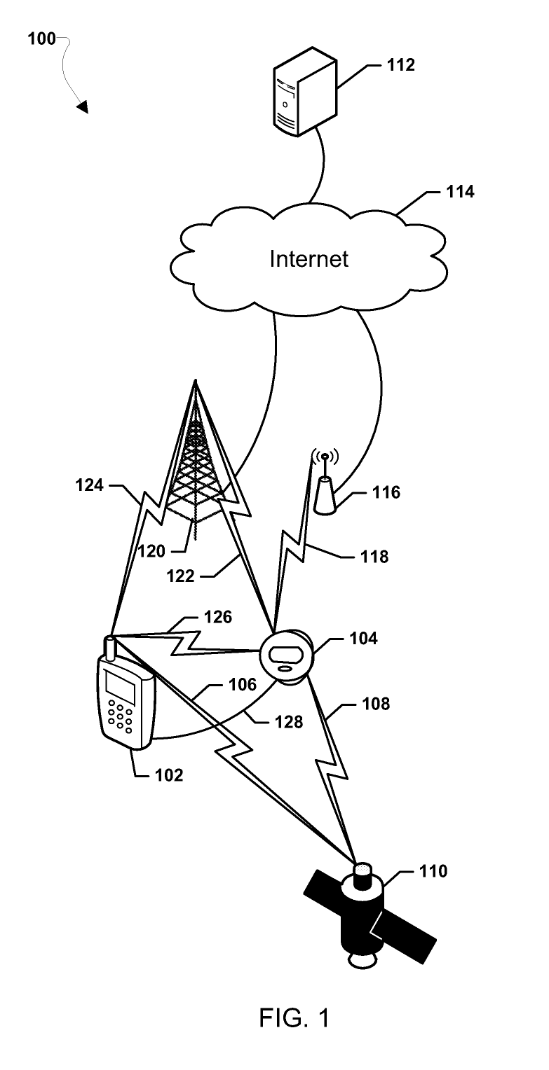

FIG. 1 illustrates a network system 100 suitable for use with the various embodiments. The network system 100 may include multiple electronic training devices, such as a sports watch 104 and smart phone 102 in communication with a server 112 via a wireless network 120, 116 coupled to the Internet 114. In an embodiment, the sports watch 104 and smart phone 102 may each be associated with a different individual user. The sports watch 104 and smart phone 102 may each include a navigation sensor (such as a GPS receiver) that receives reference signals 108 and 106, respectively, from a navigation system 110, such as GPS signals from GPS satellites, to determine its position (e.g., latitude, longitude, and/or altitude). The sports watch 104 may be configured to connect to the Internet 114 via wireless connection 118 established with a wireless access point 116, such as a Wi-Fi access point. The wireless access point 116 may connect with the Internet 114, and the server 112 may be connected to the Internet 114. In this manner, data may be exchanged between the sports watch 104 and the server 112 by methods well known in the art. Additionally, the smart phone 102 and the sports watch 104 may exchange data with a cellular data network 120 (e.g., CDMA, TDMA, GSM, PCS, G-3, G-4, LTE, or any other type of cellular data network) that may be in communication with a router connected to the Internet 114 via cellular connections 124 and 122, respectively. In this manner, data may be exchanged between the server 112 and the smart phone 102 and sports watch 104 by methods well known in the art. In an embodiment, the smart phone 102 and the sports watch 104 may exchange data via one or more wireless connections 126. As an example, the one or more wireless connections 126 between the smart phone 102 and the sports watch 104 may be one or more Bluetooth® connections, one or more Peanut connections, one or more Wi-Fi connections, one or more ANT+ connections, and/or one or more of any other type radio connections. In another embodiment, the smart phone 102 and the sports watch 104 may exchange data via one or more wired connections 128, such as a Universal Serial Bus (USB) connection. The one or more wireless connections 126 and/or wired connections 128 may enable the smart phone 102 and sports watch 104 to share data which may enable the smart phone 102 and sports watch 104 to operate together to perform the operations of the various embodiments. As an example, the sports watch 104 may determine location information and send the location information to the smart phone 102 via the one or more wireless connections 126 and/or wired connections 128, and the smart phone 102 may send the location information to the server 112.

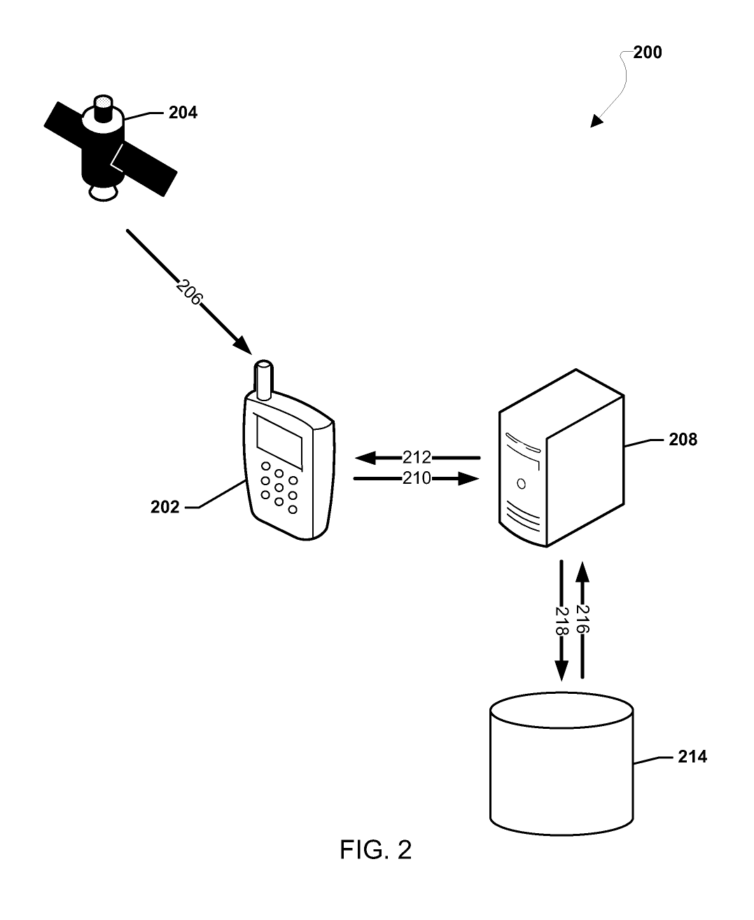

FIG. 2 is a communications flow diagram illustrating example interactions in a communication system 200 including a GPS system 204, electronic training device, such as a smart phone 202, server 208, and database 214. In an embodiment, the smart phone 202 may receive GPS reference signals 206 from the GPS system 204. A GPS receiver of the smart phone 202 may use the GPS reference signals 206 to determine a series of real-time positions of the smart phone 202, including the latitude, longitude, and altitude (i.e., elevation) of the smart phone 202. In an embodiment, the smart phone 202 may transmit the series of positions to the server 208 in a message 210, such as a HTTP message sent over a wireless network. The server 208 may receive the message 210 and may store the series of positions as a segment 218 in the database 214 of training segments. The server 208 may retrieve one or more routes and/or training segments 216 from the database 214 of training segments and may compare the series of positions to the one or more routes and/or training segments 216 to identify a training segment and/or series of training segments including at least a portion of the series or positions. The server 208 may transmit training information 212 related to the identified training segment and/or series of training segments to the smart phone 202. In an embodiment, the smart phone 202 may display the training information 212 related to the identified training segment and/or series of training segments.

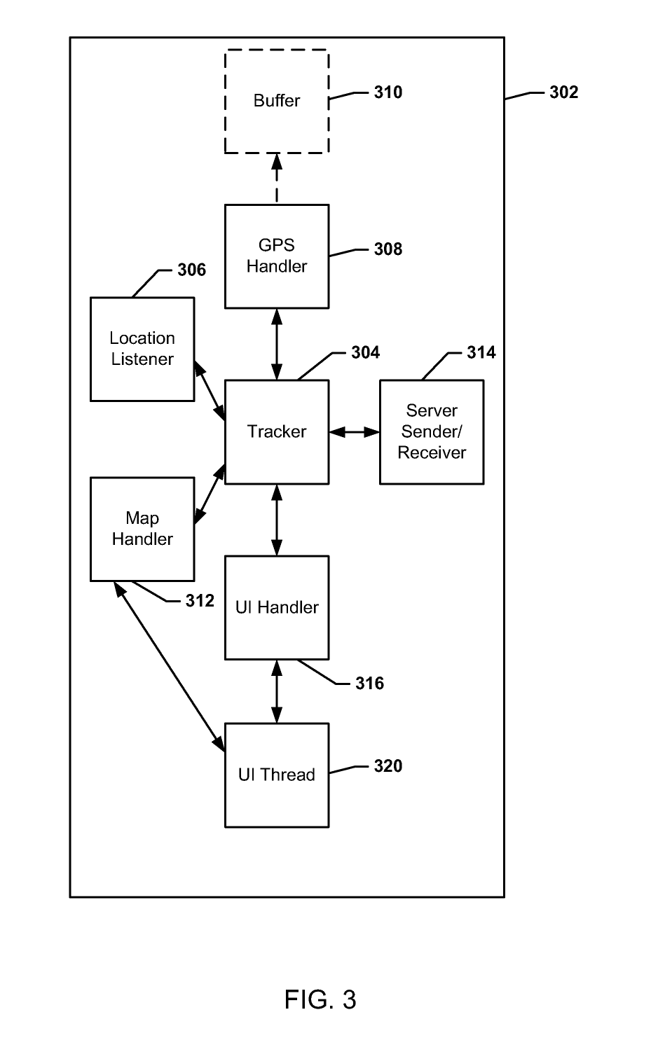

FIG. 3 is a component and functional block diagram of an electronic training device 302 suitable for use with the various embodiments. The electronic training device 302 may included a tracker module 304, location listener module 306, GPS handler module 308, buffer 310, map handler module 312, user interface (“UI”) handler module 316, UI thread module 320, and server sender/receiver module 314. In an embodiment, the tracker module 304 may control the operation of the location listener module 306, GPS handler module 308, buffer 310, map handler module 312, UI handler module 316, UI thread module 320, and server sender/receiver module 314 during an athletic training session. In an embodiment, a new athletic training session may be generated by the tracker module 304 each time the electronic training device 302 is activated. The location listener module 306 may include and/or control the operations of a navigation sensor of the electronic training device 302, such as a GPS receiver. The location listener module 306 may turn on and off the GPS receiver. In an embodiment, the location listener module 306 may determine whether a position of the electronic training device 302 has changed and when the position has changed may provide the new position to the tracker module 304. As an example, by comparing the current GPS position to a last determined GPS position, the location listener module 306 may determine the current position is different from the last position and in response may send the current positions GPS coordinates (e.g., latitude, longitude, and altitude) to the tracker module 304.

In an embodiment, the tracker module 304 may send the current position received from the location listener module 306 to a GPS handler module 308. In an optional embodiment, the GPS handler module 308 may store the position information (e.g., GPS coordinates) in a buffer 310. In an optional embodiment, the GPS handler module 308 may perform calculations using newly received position information and position information stored in the buffer 310 to account for navigation sensor errors and determine training information and/or characteristics of training segments traveled by the electronic training device 302. As an example, the GPS handler module 308 may compare the current position information to the last received position information to determine whether a difference between the current and last position is above a threshold. When the difference is above a threshold the GPS handler module 308 may average the current and last positions together, which may account for errors in the data received from the navigation sensor. As an additional example, the GPS handler module 308 may compare the current position information to the last position information to determine training information and/or characteristics of the last training segment, such as distance traveled, speed, grade, and power exerted. In an embodiment, the electronic training device 302 may be continually communicating position information to a server and the position information may not be buffered by the GPS handler module 308.

In an embodiment, the GPS handler module 308 may provide the current position information and any determined training information and/or characteristics to the tracker module 304 which may provide the current position information and any determined training information and/or characteristics to the server sender/receiver module 314. In an embodiment, the server sender/receiver module 314 may store the current position information and any determined training information and/or characteristics until the distance covered by the positions is equal to or greater than a segment size, such as 50 meters. When the distance between the received positions equals or exceeds that segment size the server sender/receiver module 314 may format the position information including any determined training information and/or characteristics and send the position information to a server. The server sender/receiver module 314 may also send a user and/or device ID as well as a session and/or route ID with the position information sent to the server. In an embodiment, the server sender/receiver module 314 may receive training information from the server, and may provide the training information from the server to the tracker module 304.

In an embodiment, the tracker module 304 may provide the training information from the server to the map handler module 312. The map handler module 312 may utilize the training information to generate a map including the route information, navigation indications, etc., and the map handler module 312 may provide the generated map to the UI thread module 320 for output on a display of the electronic training device. In an embodiment, the tracker module 304 may provide the training information from the server to the UI handler module 316. The UI handler module 316 may parse the training information to determine UI elements which may need updating, update UI elements as necessary, and send the updated UI elements to the UI thread module 320 for output on a display of the electronic training device.

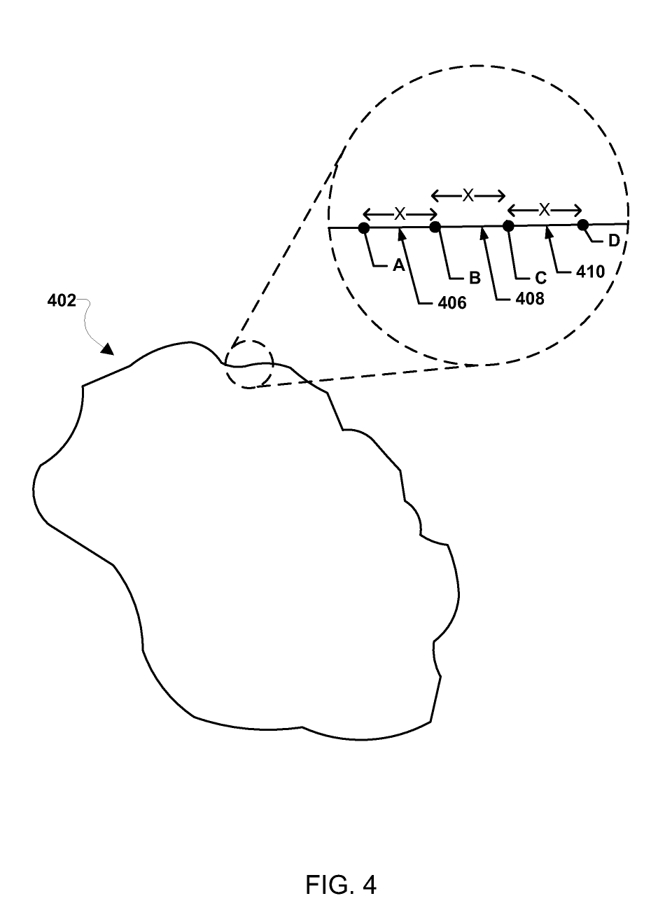

FIG. 4 illustrates an example route 402. In an embodiment, a route may be comprised of a series of segments. As illustrated in the enlarged view of a portion of the route 402, the route 402 may be comprised of a series training segments, such as training segments 406, 408, and 410. In an embodiment, the training segments 406, 408, and 410 may be of an equal and predetermined size, such as length X. In an embodiment, the segment size may be different depending on the mode of travel over the route 402. As an example, in a walking route the segment size may be 50 meters, and in a bike route the segment size may be 500 meters. The training segments 406, 408, and 410 may have defined starting points and end points. As an example, the training segment 406 may start at point A and end at point B. The starting point of training segment 408 may be point B and training segment 408 may end at point C. Training segment 410 may start at point C and end at point D. Additional intermediate points that are not the starting and/or ending points of the training segments 406, 408, and 410 may be included in the training segments 406, 408, and 410 between points A, B, C, and D, respectively.

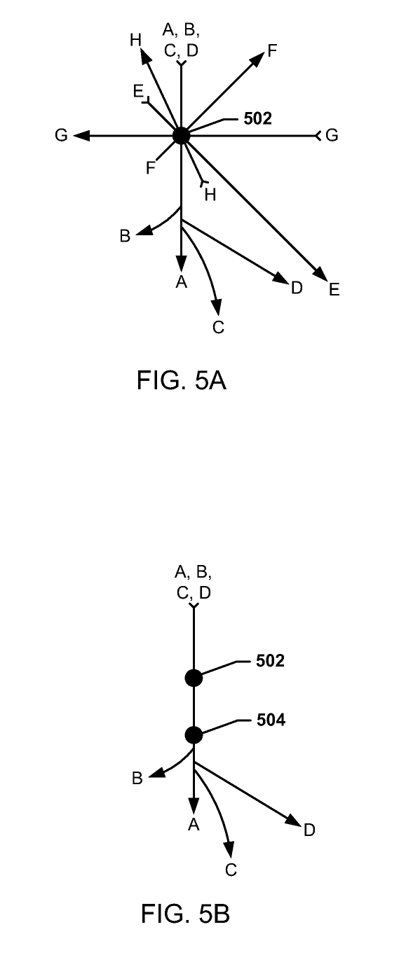

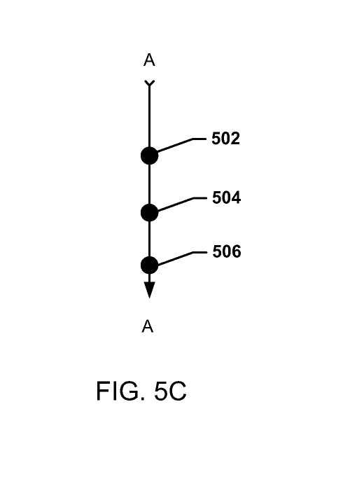

FIGS. 5A-5C illustrate the relationship between positions and training segments. In an embodiment, a server may compare a series of positions received from an electronic training device to a database of training segments to identify a training segment including at least a portion of the series of positions. As illustrated in FIG. 5A a single point 502 may be included in a number of different training segments, such as training segments A, B, C, D, E, F, G, and H. As an example, the single point 502 may correspond to the initial point at which a user of an electronic training device started their run. The different training segments A, B, C, D, E, F, G, and H may have different orientations, directions, starting points, and endpoints, but all the training segments A, B, C, D, E, F, G, and H may pass through the point 502. The identification of a single point 502 as illustrated in FIG. 5A may be of only minimal use in narrowing the selection to a specific training segment because multiple training segments A, B, C, D, E, F, G, and H may share the single point 502. FIG. 5B illustrates a later time, for example a few moments into the user of the electronic device's run, when a second point 504 may be available. The server may receive the second point 504 and using the first point 502 and second point 504 may narrow the possible training segments to training segments A, B, C, and D because these may be the only training segments which include both the first point 502 and the second point 504. FIG. 5C illustrates a third time, for example later in the user of the electronic device's run, when a third point 506 may be available. The server may receive the third point 506 and using the first point 502, second point 504, and third point 506 may identify that only training segment A may include the first point 502, second point 504, and third point 506. In this manner, the server may identify a training segment A including at least a portion of the series of positions 502, 504, and 506 and may transmit training information related to training segment A to the electronic training device.

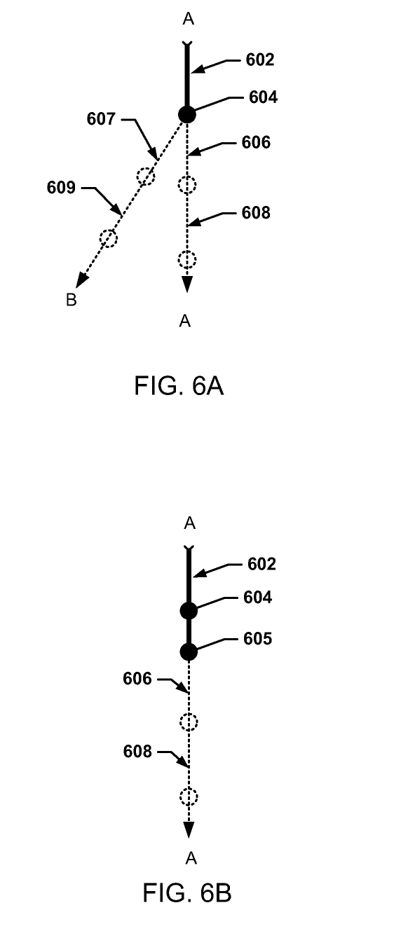

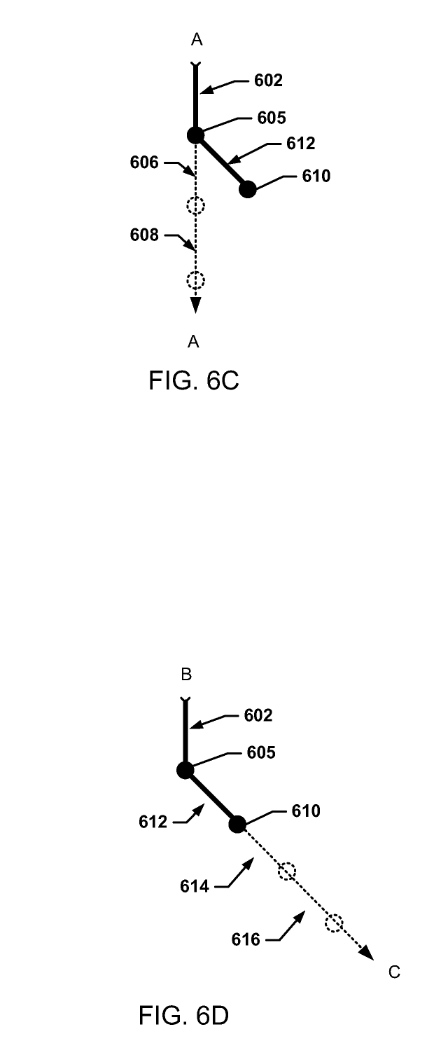

FIGS. 6A-6D illustrate the relationship between a new position and a string of training segments. FIG. 6A illustrates an embodiment in which an electronic training device has sent a series of positions to the server indicating the electronic training device has previously traveled over segment 602 of route A and is currently at point 604. The server may have identified that the string of segments 602, 606, and 608 have similar characteristics, such as distance and grade, to a training route A. In an embodiment, training route A may be a training route of a user of the electronic training device or a training route of another individual, such as an individual sharing a common attribute, such as age, weight, fitness level, etc., with the user of the electronic device. The server may determine that training segments 606 and training segments 608 may be traveled by the user of the electronic device and may transmit training information related to the string of segments 602, 606, and 608 to the electronic device.

In an embodiment, more than one route may share the same segments, for example, segment 602 may be common to both route A and route B. The server may have identified that the string of segments 602, 607, and 609 also have similar characteristics, such as distance and grade, to a training route B. In an embodiment, similar to training route A, training route B may be a training route of a user of the electronic device or a training route of another individual, such as an individual sharing a common attribute, such as age, weight, fitness level, etc., with the user of the electronic device. The server may determine that training segments 607 and training segments 609 may be traveled by the user of the electronic training device and may transmit training information related to the string of segments 602, 607, and 609 to the electronic device as well. In this manner, because a plurality of routes (e.g., route A and route B) may possibly be traveled by the user from point 604, the server may transmit training information for the plurality of routes. In an embodiment, the electronic training device may display the plurality of received training routes, for example to give the user of the electronic training device options in choosing to follow routes related to the user's workout goals.

FIG. 6B illustrates a later point in time when the server may receive a new current location of the electronic training device 605. The server may determine that the new current location 605 does not correspond to training route B, specifically the string of segments 602, 607, and 609. In an embodiment, upon determining the new current location 605 does not correspond to training route B, the server may cease transmitting training information related to route B and/or a stop presentation indication for training route B. In an embodiment, the electronic training device may receive a stop presentation indication for training route B and/or not receive further training information for training route B, and therefore may stop presenting training information related to training route B.

FIG. 6C illustrates a later point in time when the server may receive a new current location of the electronic training device 610. The server may determine that the new current location 610 does not correspond to the previous string of segments, specifically training segments 606 and 608. The new current location 610 may not correspond to the previous string of segments because the use of the electronic training device may have changed direction and traveled over a training segment 612 which does not correspond to previously identified route A. As illustrated in FIG. 6D, in response to determining the new current location 610 of the electronic training device does not correspond to the string of segments 606 and 608, the server may identify a new string of training segments 612, 614, and 616 having characteristics, such as distance and grade, similar to the another training route, such as training route C. In an embodiment, training route C may be a training route of a user of the electronic training device or a training route of another individual, such as an individual sharing a common attribute, such as age, weight, fitness level, etc., with the user of the electronic device. In an embodiment, the server may transmit to the electronic training device training information related to the new string of training segments 612, 614, and 616.

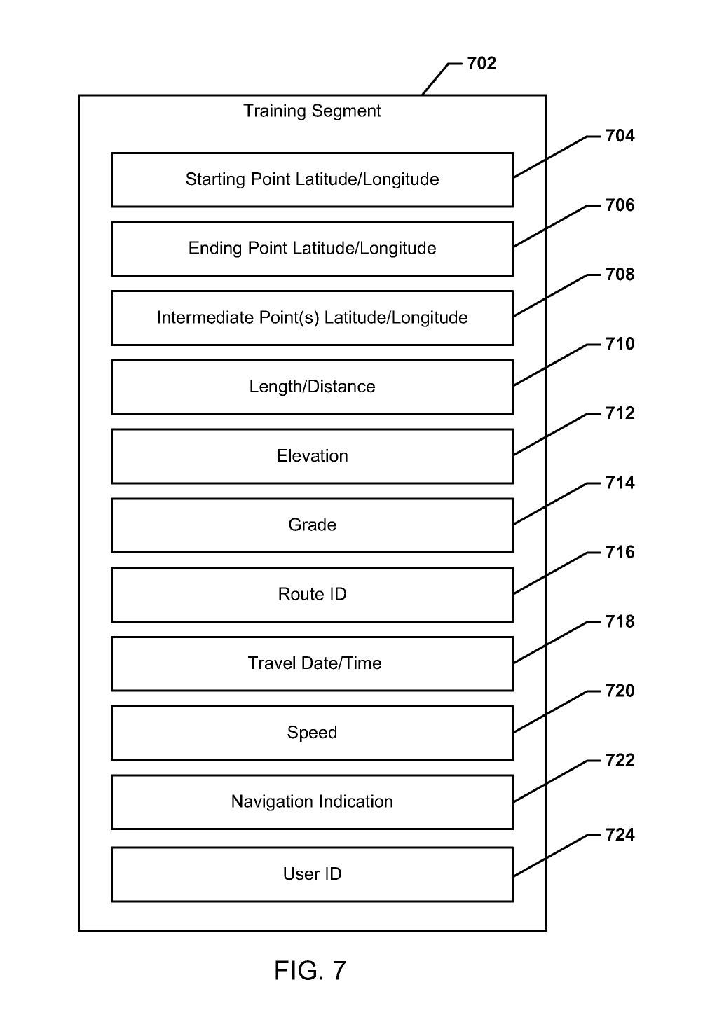

FIG. 7 is a data structure diagram illustrating potential elements of a training segment 702. In an embodiment, a training segment 702 may be a file stored in a database available to a server. The elements within a training segment 702 may be training information related to the training segment 702. In an embodiment, a series of training segments 702 may comprise a route. In an embodiment, a training segment 702 may include a starting point latitude and longitude. As an example, a starting point latitude and longitude may be a GPS coordinate corresponding to the starting point for the training segment 702. In an embodiment, a training segment 702 may include an ending point latitude and longitude 706. As an example, a starting point latitude and longitude 706 may be a GPS coordinate corresponding to the ending point for the training segment 702. In an embodiment, a training segment 702 may include one or more intermediate points' latitude and longitude 708. As an example, the training segment 702 may be comprised of multiple points extending from a starting point to an ending point in a direct or circuitous path, and the intermediate points' latitude and longitude 708 may correspond to GPS coordinates along the direct or circuitous path between the starting point and ending point of the training segment 702. In an embodiment, the training segment 702 may include a length/distance indication 710. As an example, the length/distance indication 710 may be the total length of the training segment 702. As another example, the length/distance indication may be a distance of the total route for which the training segment is a portion. In this manner, training segments that are portions of long workouts, such as long runs, may be distinguished from training segments which are portions of short workouts, such as short runs even though the training segments may correspond to the same geographic points. In an embodiment, the training segment 702 may include an elevation indication 712. As an example, an elevation indication may be an altitude (e.g., height above sea level), for the training segment. The GPS coordinates for the training segment 702 may include altitude indications and the elevation may be an average of the altitudes over the length of the training segment 702. In an embodiment, the training segment 702 may include a grade indication 714. As an example, grade indication may be determined by comparing altitude indications over the length of the training segment 702. In an embodiment, a training segment may include a route ID 716 for the route of which the training segment 702 is a portion. In an embodiment, a training segment 702 may include an indication of the travel data and time 718 when the training segment 702 was recorded by an electronic training device. In an embodiment, the training segment 702 may include a speed indication 720. As an example, a speed indication 720 may be an indication of the speed at which the length of the training segment 702 was traveled. In an embodiment, the training segment 702 may include a navigation indication 722. As an example, a navigation indication may be a heading, such as north, south, etc., identifying a direction of the training segment 702 from the starting point to the ending point. In an embodiment, the training segment 702 may include a user ID 724. As an example, the user ID 724 may be a unique user number assigned to a user of an electronic device and/or a unique device number assigned to the electronic device, such as a phone number.

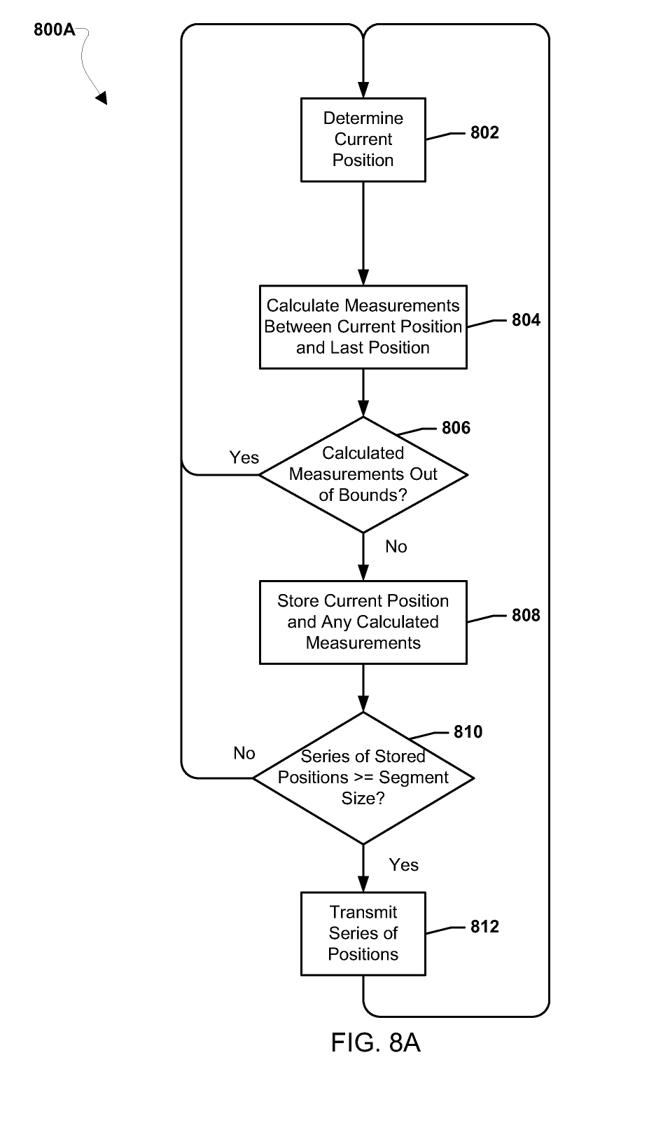

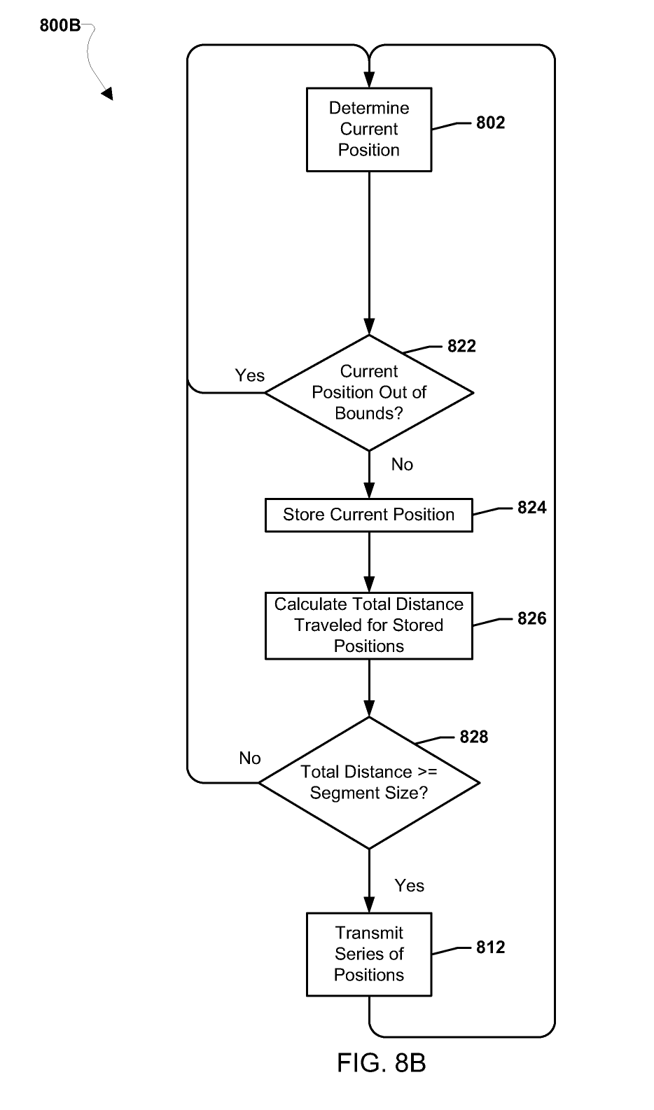

FIG. 8A illustrates an embodiment method 800A for determining and transmitting a series of positions to a server. In an embodiment, the operations of method 800A may be performed by the processor of an electronic training device, such as a smart phone or sports watch.

In block 802 of method 800A the electronic training device processor may determine the current position of the electronic training device. In an embodiment, the electronic training device processor may determine the current position by obtaining in real-time a series of positions of the electronic training device from a position sensor. As an example, the electronic training device processor may use a GPS receiver to determine the current latitude, longitude, and altitude of the electronic training device. In block 804 the electronic training device processor may calculate measurements (i.e., distances) between the current position and the last recorded position. As examples, the distances between the current position and the last recorded position indicates the distance traveled, and when divided by the intervening time (which may be determined from time stamps in the position reports), the average speed of travel. The difference in altitude between the current position and the last recorded position divided by the distance traveled may be used to determine the average grade of the path traveled. In an embodiment, only a limited number of measurements may be calculated by the electronic training device processor, for example distance between the current position and last recorded position but not speed of travel, and any necessary additional measurements may be calculated by a server receiving a series of positions from the electronic training device. In determination block 806 the electronic training device processor may determine whether any of the calculated measurements are out of bounds or likely in error. As an example, the electronic training device processor may compare the traveled distance to a distance threshold, and traveled distances above the threshold may be determined to be out of bounds. In this manner, the electronic training device processor may identify erroneous position determinations, for example erroneous position determinations that result in traveled distances beyond a human athlete's ability. If the calculated measurement is out of bounds (i.e., determination block 806=“Yes”), in block 802 the electronic training device processor may re-determine the current position of the electronic training device.

If the calculated measurement is not out of bounds (i.e., determination block 806=“No”), in block 808 the electronic training device processor may store the current position and any calculated measurements in a memory of the electronic training device. In determination block 810 the electronic training device processor may determine whether the series of stored positions in the memory of the electronic training device is greater than or equal to a segment size. As an example, the electronic training device processor may determine the total distance traveled from the first position stored in the memory of the electronic training device to the most recent position stored in the memory of the electronic training device and compare that total distance traveled to a stored segment size, such as 50 meters, to determine whether the total distance traveled is greater than or equal to the stored segment size. If the series of stored positions in the memory of the electronic training device is less than the segment size (i.e., determination block 810=“No”), in block 802 the electronic training device processor may determine the current position again. In this manner, until a segment sized is reached, the electronic training device processor may continually determine and store the current position. If the series of stored positions in the memory of the electronic training device is greater than or equal to the segment size (i.e., determination block 810=“Yes”), in block 812 the electronic training device processor may transmit the series of positions stored in the memory of the electronic training device to a server.

FIG. 8B illustrates an embodiment method 800B for determining and transmitting a series of positions to a server similar to method 800A described above with reference to FIG. 8A, except that in method 800B calculations related to the series of positions may not be stored with the positions and not be transmitted with the series of positions. In an embodiment, the operations of method 800B may be performed by the processor of an electronic training device, such as a smart phone or sports watch.

As discussed above, in block 802 the electronic training device processor may determine the current position of the electronic training device. As an example, the electronic training device processor may use a GPS receiver to determine the current latitude, longitude, and altitude of the electronic training device. In determination block 822 the electronic training device processor may determine whether the current position is out of bounds or likely in error. As an example, the electronic training device processor may compare a calculated traveled distance between the current position and the last recorded position to a distance threshold, and traveled distances above the threshold may be determined to be out of bounds. In this manner, the electronic training device processor may identify erroneous position determinations before storing the positions. For example, erroneous GPS coordinates may be coordinates indicating traveled distances beyond a human athlete's ability. If the current position is out of bounds (i.e., determination block 822=“Yes”), in block 802 the electronic training device processor may re-determine the current position of the electronic training device.

If the current position is not out of bounds (i.e., determination block 822=“No”), in block 824 the electronic training device processor may store the current position in a memory of the electronic training device. In an embodiment, the raw current position without any calculated measurements related to the current position may be stored in the memory of the electronic training device. In block 826 the electronic training device processor may calculate the total distance traveled for the stored positions. As an example, the electronic training device may calculate the distance between the first stored position and the most recent stored position (i.e., the current stored position) to calculate the total distance traveled for the stored positions. As another example, the electronic training device may sum the distances between each successive stored position to calculate the total distance traveled for the stored positions. In determination block 828 the electronic training device processor may determine whether the total distance traveled for the series of stored positions in the memory of the electronic training device is greater than or equal to a segment size. As an example, the electronic training device processor may compare the calculated total distance traveled to a stored segment size, such as 50 meters, to determine whether the total distance traveled is greater than or equal to the stored segment size. If the series of stored positions in the memory of the electronic training device is less than the segment size (i.e., determination block 828=“No”), in block 802 the electronic training device processor may determine the current position again. In this manner, until a segment sized is reached, the electronic training device processor may continually determine and store current positions. If the series of stored positions in the memory of the electronic training device is greater than or equal to the segment size (i.e., determination block 828=“Yes”), in block 812 the electronic training device processor may transmit the series of positions stored in the memory of the electronic training device to a server as discussed above. In an alternative embodiment, as the electronic training device processor determines the current position of the electronic training device the current position of the electronic training device may be transmitted to the server.

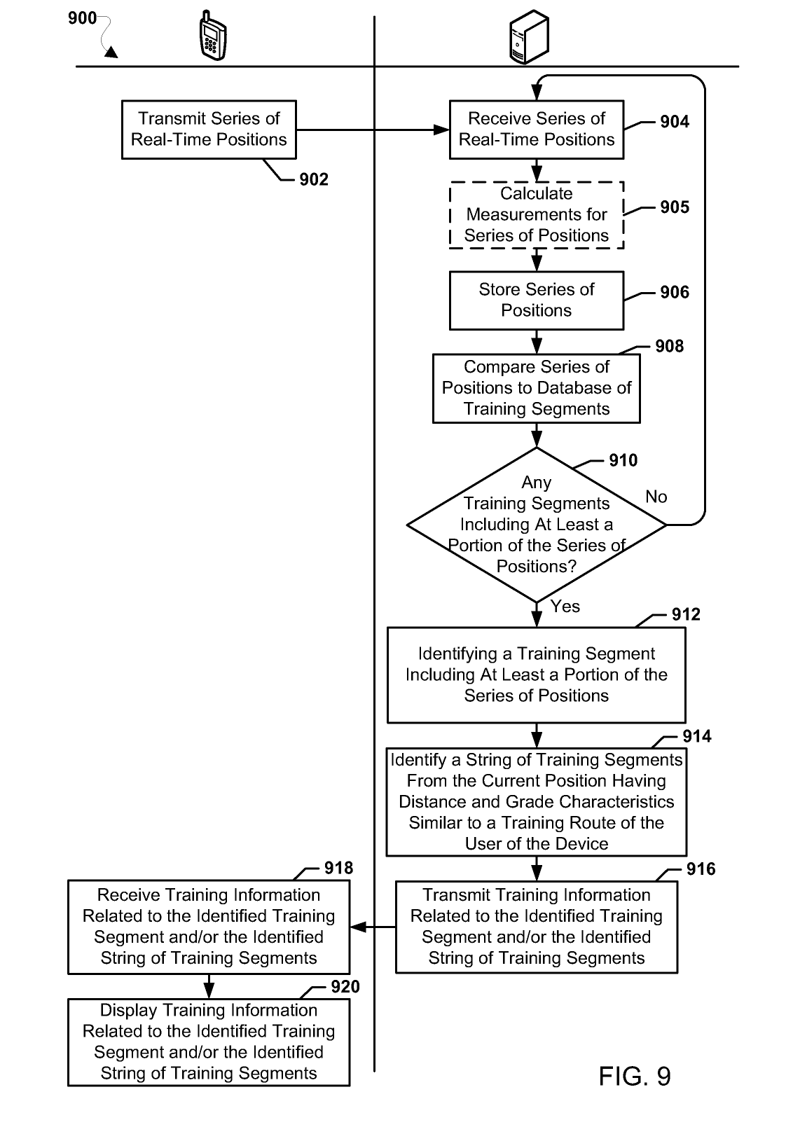

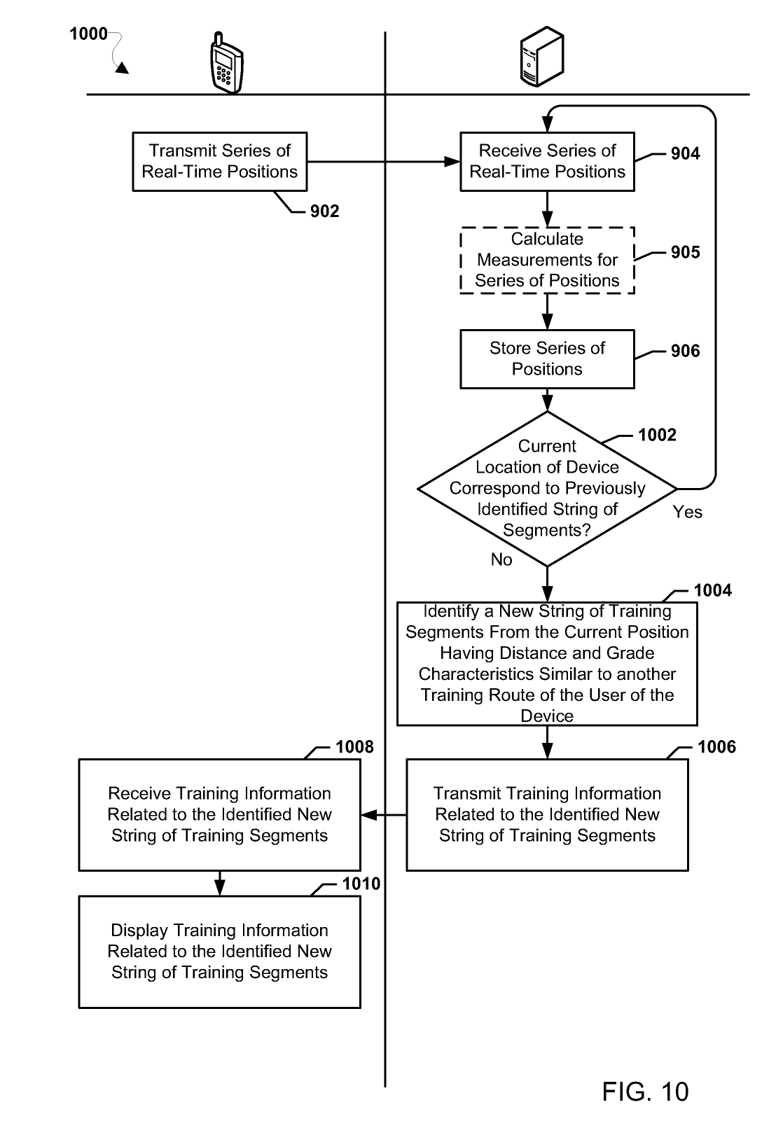

FIG. 9 illustrates an embodiment method 900 for transmitting training information related to an identified training segment and/or string of training segments to an electronic training device from a server. In an embodiment, the operations of method 900 may be performed by the processor of an electronic training device, such as a smart phone or sports watch, which may be in communication with a server. In block 902 the electronic training device processor may transmit a series of real-time positions to the server. In an embodiment, the series of real-time positions may be a series of GPS coordinates, including latitude, longitude, altitude, and other calculated measurements for a path currently being traveled by the user of the electronic training device. In another embodiment, the series of real-time positions may be a series of GPS coordinates without calculated measurements for a path currently being traveled by the user of the electronic training device. In an embodiment, the electronic training device processor may continually transmit series of real-time positions to the server. In block 904 the server may receive the series of real-time positions. In an embodiment, in optional block 905 the server may calculate measurements for the series of positions. In an embodiment in which the series or real-time positions includes no calculated measurements or less than all the necessary calculated measurements, the server may calculate any necessary measurements for the series of positions. As examples, the distances between the positions in the series of positions may indicate the distance traveled, and when divided by the intervening time (which may be determined from time stamps in the position reports), the average speed of travel. The difference in altitude between the positions in the series of positions divided by the distance traveled may be used to determine the average grade of the path traveled. In block 906 the server may store the series of real-time positions and any calculated measurements include in the series of positions and/or calculated by the server, for example in a database of training segments available to the server. In this manner, the received series of positions and any calculated measurements may be stored regardless of whether the received series of positions may be similar to any previously stored route.

In block 908 the server may compare the series of positions to the database of training segments. As an example, the server may compare characteristics of the series of positions, such as latitude and longitude, distance, and grade, to the training segments stored in the database of training segments. In determination block 910, the server may determine whether any training segments stored in the database of training segments include at least a portion of the series of positions. As an example, the server may compare GPS coordinates included in the series of positions to GPS coordinates included in the database of training segments to identify matching GPS coordinates. If no training segments include at least a portion of the series of positions (i.e., determination block 910=“No”), in block 904 the server may return to block 904 and await the receipt of the next series of real-time positions form the electronic training device.

If a training segment includes at least a portion of the series of positions (i.e., determination block 910=“Yes”), in block 912 the server may identify a training segment including at least a portion of the series of positions. As an example, the server may identify a training segment including at least a portion of the series of positions by selecting a training segment from the database of training segments which shares the most positions in common with the series of positions. In block 914 the server may identify a string of training segments from the current position having distance and grade characteristics similar to a training route of the user of the electronic training device. As an example, the user of the electronic training device may have previously recorded a training route in the database of training segments which was a three kilometer total distance route over a three percent average grade. The server may identify a string of segments from the current position that are equal to the three kilometer total distance and also have a three percent average grade. In this manner, the user's past training route information may be used to select strings of training segments, even though the user of the electronic training device may not currently be on a training segment or route they have ever previously traveled. In block 916 the server may transmit training information related to the identified training segment and/or the identified string of training segments to the electronic training device. In an embodiment, the training information related to the identified training segment and/or the identified string of training segments may be sent as a training information message. As discussed further below, training information may include a navigation indication identifying a direction of the training segment and/or string of training segments, performance data for the user over the previous training segment, performance data for another individual over the next segment in the string of segments, etc.

In block 918 the electronic training device processor may receive the training information related to the identified training segment and/or the identified string of training segments from the server, and in block 920 the electronic training device processor may display the training information related to the identified training segment and/or the identified string of training segments on a display of the electronic training device. As an example, the electronic training device processor may output a display showing the current position, total workout time, distance traveled, a map of the path traveled, a turn indication, such as an arrow, showing the direction of the next segment, a pace goal for the next segment, and the fastest pace of any other individual who previously traveled the next segment using the training information received from the server.

FIG. 10 illustrates an embodiment method 1000 which may be used in conjunction with method 900 described above with reference to FIG. 9 to identify and transmit training information related to a newly identified string of training segments. In an embodiment, the operations of method 1000 may be performed by the processor of an electronic training device, such as a smart phone or sports watch, which may be in communication with a server. As discussed above, in block 902 the electronic training device processor may transmit a series of real-time positions to the server, in block 904 the server may receive the series of real-time positions, in block 905 the server may calculate measurements for the series of real-time positions, and in block 906 the server may store the series of real-time positions in the training segment database.

In block 1002 the server may determine whether a new current location of the electronic training device may correspond to a previously identified string of segments. As an example, the server may compare the GPS coordinates of the series of real-time positions to the GPS coordinates of the previously identified string of segments to determine whether the GPS coordinates match. GPS coordinates that may not match may indicate the user of the electronic training device may have deviated from a previously identified route of training segments. In this manner, the server may recognize that a new current location of the electronic training device does not correspond to the previously identified string of segments. If the current location of the electronic training device corresponds to a previously identified string of segments (i.e., determination block 1002=“Yes”), in block 904 the server may receive the next series of real-time positions, in block 906 may store the next series of real-time positions, and in determination block 1002 again determine whether the current location of the electronic training device corresponds to the previously identified string of segments. In this manner, the server may continually check the current location of the electronic training device to determine whether the current location corresponds to the previously identified string of segments which may enable the server to identify changes in the travel path of the user of the electronic device.

If the current location of the electronic training device does not correspond to the previously identified string of segments (i.e., determination block 1002=“No”), in block 1004 the server may identify a new string of training segments from the current position having distance and grade characteristics similar to another training route of the user of the device. In this manner, the server may continually compare the current travel path to previous routes, and if applicable update the previous route to which the server may be comparing the current travel path of the user of the electronic training device. In block 1006 the server may transmit the training information related to the identified new string of training segments to the electronic training device, and in block 1008 the electronic training device processor may receive the training information related to the identified new string of training segments. In block 1010 the electronic training device processor may display the training information related to the identified new string of training segments on a display of the electronic training device. As an example, the electronic training device processor may update a display to show a new turn indication, such as an arrow, showing the direction of a new next segment.

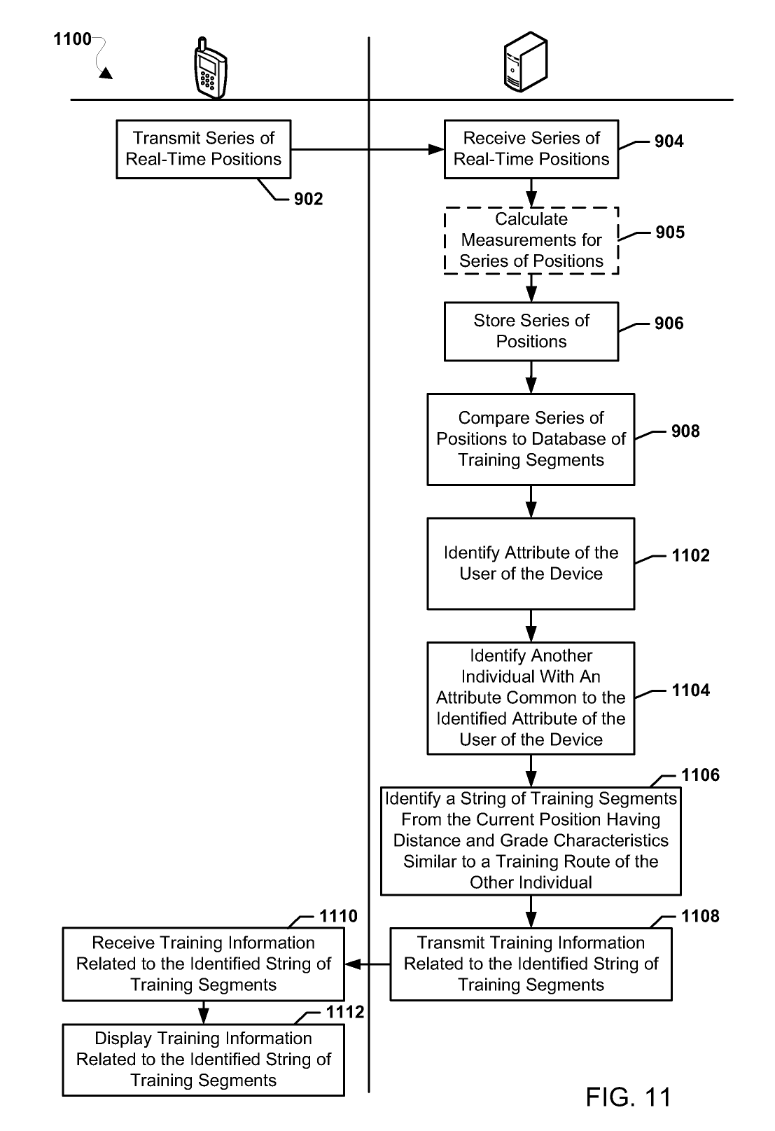

FIG. 11 illustrates an embodiment method 1100 similar to method 900 described above with reference to FIG. 9, except that method 1100 a string of training segments from a current position similar to a training route of another individual may be identified and transmitted to the electronic training device from the server. In an embodiment, the operations of method 1000 may be performed by the processor of an electronic training device, such as a smart phone or sports watch, which may be in communication with a server. As discussed above, in block 902 the electronic training device processor may transmit a series of real-time positions to the server. In blocks 904, 905, 906, and 908 the server may perform the operations of like numbered blocks of method 900 described above with reference to FIG. 9 to receive the series of real-time positions, calculate measurements, store the series of real-time positions, and compare the series of positions to a database of training segments.

In block 1102 the server may identify an attribute of the user of the electronic training device. As an example, attributes, such as age, weight, performance goals, gender, experience level, etc., may be stored in the database of training segments for each user ID associated with a training route, and the server may identify one or more of those stored attributes for the current user of the electronic training device. In block 1104 the server may identify another individual with an attribute in common with the identified attribute of the user of the electronic training device. As an example, the server may identify another individual with the same age, weight, and experience level as the user of the electronic training device. In block 1106 the server may identify a string of training segments from the current position having distance and grade characteristics similar to a training route of the other individual identified in block 1104. In this manner, though data may not be available for training routes of the user of the electronic training device, for example upon a first use of the electronic training device, a string of potentially relevant training segments may still be identified by the server. In block 1108 the server may transmit training information related to the identified string of training segments to the electronic training device. In block 1110 the electronic training information related to the identified string of training segments may be received by the electronic training device processor. In block 1112 the electronic training device processor may display the training information related to the identified string of training segments on a display of the electronic training device. As an example, the electronic training device processor may display a navigation indication, such as a turn arrow, identifying a direction of the string of training segments and the user ID of the other individual who previously traveled the training segment.

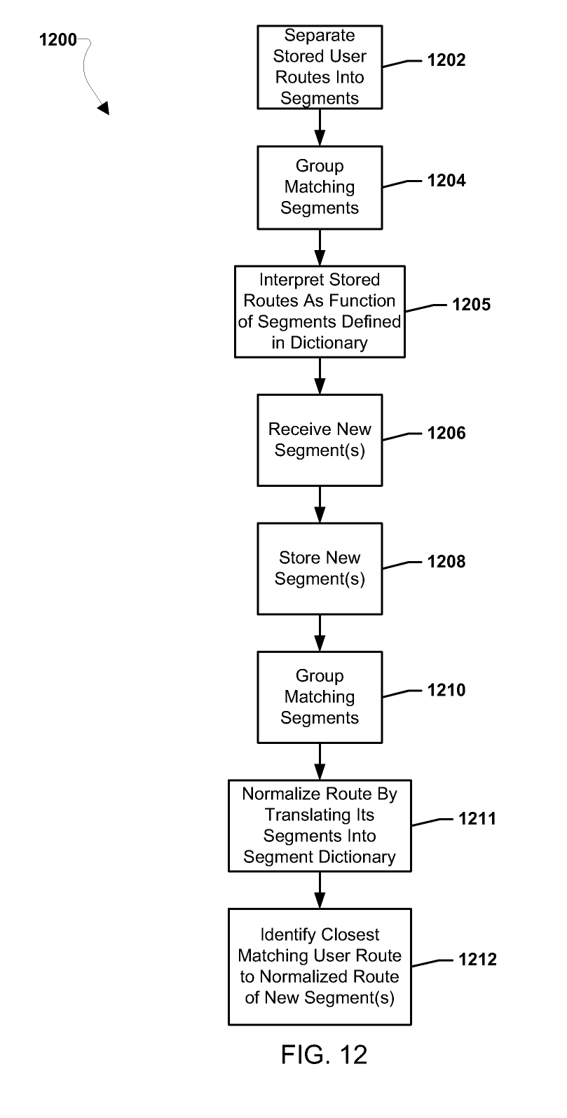

FIG. 12 illustrates an embodiment method 1200 for identifying a closest matching user route. In an embodiment, the operations of method 1200 may be performed by a server in conjunction with the operations of methods 900, 1000, and/or 1100 described above with reference to FIGS. 9, 10, and 11, respectively. In block 1202 the server may separate stored user routes in a database into segments. As an example, using a stored segment size, all previously traveled routes stored in a database may be divided into segments. In block 1204 matching segments may be grouped together. As an example, matching segments may be those segments which have common GPS coordinates and/or GPS coordinates within a specific distance of each other. In this manner, a dictionary (e.g., a database) of matching segments grouped together may be created and used for reference. In block 1205, each stored route may be interpreted as a function of the segments defined in the segments dictionary. In this manner, data normalization may enable all routes to be defined as a function of the same segments. In an embodiment, the grouping of matching segments may occur regularly, for example on a predetermined schedule, such that new routes and their corresponding segments may be integrated into the dictionary. In an embodiment, each time the grouping of matching segments is performed the old dictionary may be discarded from a memory and replaced with the newly built dictionary.

In block 1206 the server may receive a new segment or segments from an electronic training device. For example, the server may receive a new segment as a series of positions corresponding to the defined segment length from the electronic training device. In block 1204 matching segments may be grouped together. As an example, matching segments may be those segments which have common GPS coordinates and/or GPS coordinates within a specific distance of each other. In an embodiment, the server may apply a clustering algorithm to group the segments together and identify those segments defined in the segment dictionary that most closely match. In block 1211, the newly received route may be normalized by translating its segments into segments defined in the segment dictionary. In block 1212 the server may identify a closest matching user route to the normalized route of the new segment or segments. In an embodiment, the normalized route may be compared to existing routes. In this manner, the server may ensure that routes of equal value are compared. In an embodiment, the server may identify the closest matching user route by identifying a route having distance and grade characteristics similar to the new segment or segments. As an example, the received new segments may indicate the user has traveled two kilometers over a two percent average grade, and the server may identify the closest matching route as previous user route covering three kilometers at a two percent average grade.

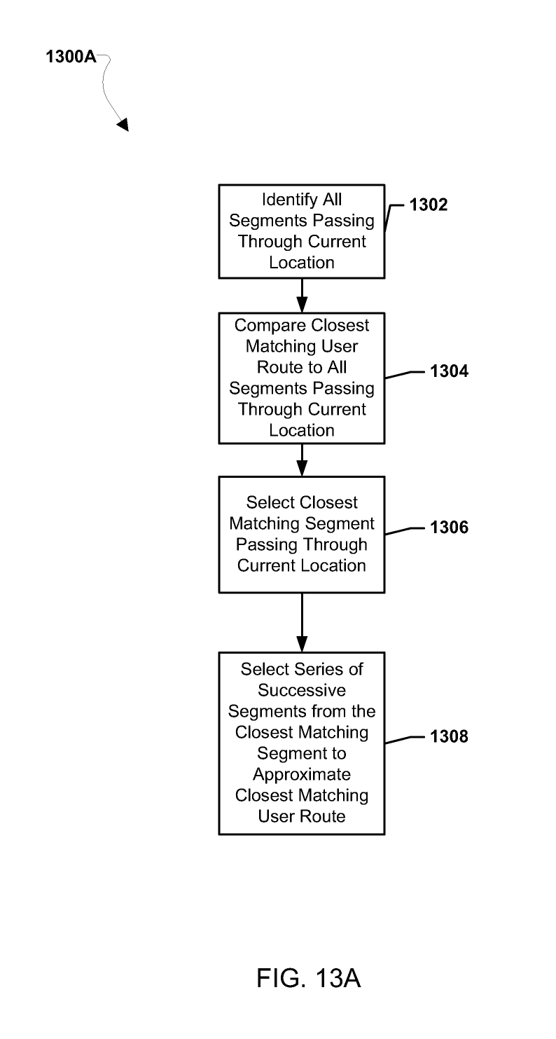

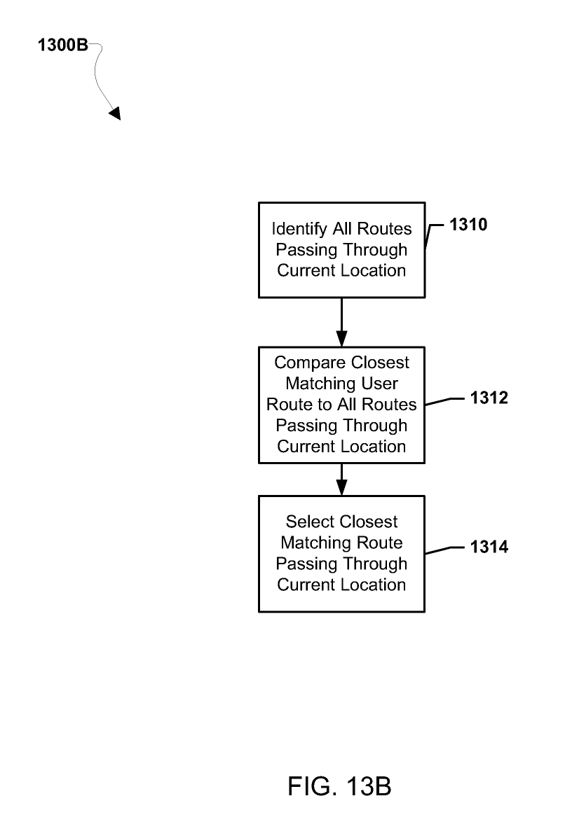

FIG. 13A illustrates an embodiment method 1300A for select a series of successive segments to approximate a user route. In an embodiment, the operations of method 1300A may be performed by a server in conjunction with the operations of methods 900, 1000, 1100, and/or 1200 described above with reference to FIGS. 9, 10, 11, and 12, respectively. In block 1302 the server may identify all segments passing though the current location of the electronic training device. In an embodiment, the current location of the electronic training device may be determined from a received new segment or segments. In block 1304 the server may compare the closest matching user route, for example the closest matching user route as determined in block 1212 described above with reference to FIG. 12, to all the segments passing through the current location identified in block 1302. As an example, the server may compare a determined current segment characteristic, such as a grade, of the closest matching user route to the characteristics of all the segments passing through the current location. In block 1306 the server may select the closest matching segment passing though the current location. In block 1308 the server may select a series of successive segments extending from the closest matching segment to approximate the closest matching user route, for example the closest matching user route as determined in block 1212 described above with reference to FIG. 12.

FIG. 13B illustrates an embodiment method 1300B for select a series of successive segments to approximate a user route. In an embodiment, the operations of method 1300B may be performed by a server in conjunction with the operations of methods 900, 1000, 1100, and/or 1200 described above with reference to FIGS. 9, 10, 11, and 12, respectively. In block 1310 the server may determine all the routes passing through the current location. In an embodiment, the current location of the electronic training device may be determined from the received new segment or segments. In block 1312 the server may compare the closest matching user route, for example the closest matching user route as determined in block 1212 described above with reference to FIG. 12, to all the routes passing through the current location. In block 1314 the server may select the closest matching route passing through the current location. In an embodiment, the closest matching route passing through the current location may be the route with the least difference per point between its various points and the points of the closest matching user, for example the closest matching user route as determined in block 1212 described above with reference to FIG. 12. In another embodiment, the closest matching route passing through the current location may be the route with the least difference between its various segments and the segments of the closest matching user route, for example the closest matching user route as determined in block 1212 described above with reference to FIG. 12.

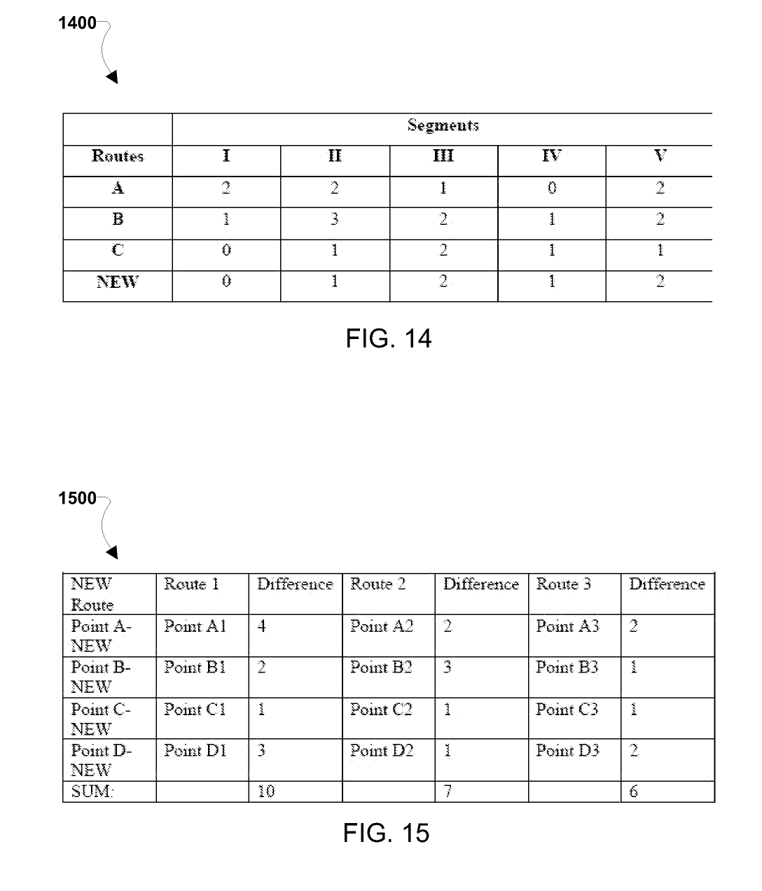

FIG. 14 is a data structure diagram illustrating potential elements of a route segment comparison table 1400. In an embodiment, a route segment comparison table 1400 may be utilized by a server to identify a most similar route to a NEW route based on the difference between characteristics of segments I, II, III, IV, and V of a NEW route and characteristics of segments I, II, III, IV, and V of previously traveled user routes A, B, and C. The characteristics, such as distance and/or grade, of each corresponding segment I, II, III, IV, and V of each route A, B, C, and NEW may be assigned a value by the server which may be populated in the route segment comparison table 1400. In an embodiment, the server may compare the NEW route with the previously traveled user routes A, B, and C to identify the previously traveled route A, B, or C with the greatest number of segments with values matching the NEW route. In an embodiment, routes may be determined to be similar by giving point values to each matching characteristic in a segment resulting in a single score for each segment. As an example, each characteristic match within a segment may be given a positive point value and each non-matching characteristic may be given a negative point value, resulting in a single score for the segment. In the example illustrated in FIG. 14 the previously traveled route C may be the closest match to the NEW route because the value assigned to four of their corresponding segments I, II, III, and IV match, which is a greater number of matching segments than shared between the NEW route and routes A and B.

FIG. 15 is a data structure diagram illustrating potential elements of a route point comparison table 1500. In an embodiment, a route point comparison table 1500 may be utilized by a server to identify a most similar route to a NEW route based on the difference per point between the points A, B, C, and D of the NEW route and the points A, B, C, and D of Routes 1, 2, and 3. The difference between a characteristics, such as latitude, longitude, and altitude, of each corresponding point A, B, C, and D each route 1, 2, 3, and the NEW route may be determined by the server and populated into the route point comparison table 1500. The server may sum the total differences for each route 1, 2, and 3. In an embodiment, the route with the lowest total difference may be the most similar route to the NEW route. In the example illustrated in FIG. 15, the previously traveled route 3 may be the closest match to the NEW route because the total difference of route 3 is less than that of routes 1 or 2.

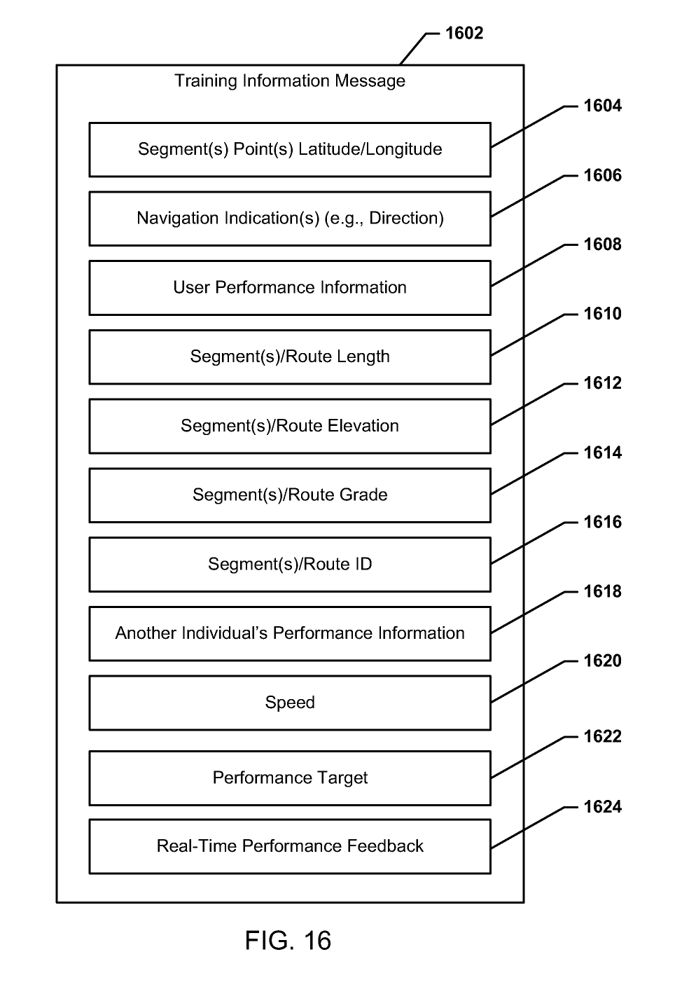

FIG. 16 is a data structure diagram illustrating potential elements of a training information message 1602. In an embodiment, a training information message 1602 may be transmitted from a server to an electronic training device, such as a smart phone or sports watch, to provide the electronic training device with training information for display. In an embodiment, a training information message 1602 may include one or more segment point's latitude and longitude 1604. In an embodiment, the training information message 1602 may include one or more navigation indication 1606 identifying a direction of a training segment. In an embodiment, the training information message 1602 may include a user performance indication 1608. As an example, a user performance indication 1608 may be an indication of a past user achievement, such as speed, power, etc., over a training segment and/or route. In an embodiment, the training information message 1602 may include a segment(s)/route length indication 1610, a segment(s)/route elevation indication 1612, and a segment(s)/route grade indication 1614. In an embodiment, the training information message 1602 may include a segment(s)/route ID 1616 which may uniquely identify the route associated with the training information message 1602. In an embodiment, the training information message 1602 may include another individual's performance information 1618. As an example, the another individual's performance information 1618 may be the speed or time at which another individual covered the next segment in a string of segments. In an embodiment, the another individual's performance information 1618 may be real-time performance information of the other individual. In this manner, the user may be given the opportunity to attempt to meet or exceed the performance of another individual currently traveling the same training segment. In an embodiment, the training information message 1602 may include a speed indication 1620. As an example, the speed indication 1620 may be an indication of the user's speed of the previous training segment and/or the user's current speed. In an embodiment, the training information message 1602 may include a performance target 1622. As examples, a performance target 1622 may be goal speed, goal time, target heart rate, target total distance, etc. for the user of the electronic training device. A performance target 1622 may be server determined based on past user performance and/or may be user selected. In an embodiment, the training information message 1602 may include a real-time performance feedback 1624. A real-time performance feedback 1624 may be an indication, such as a text based message or audio message, of the current performance of the user of the electronic training device for output by the electronic training device, such as on a display or via a speaker. As examples, a real-time performance feedback 1624 may be a message, such as “Great job,” when the user of the electronic training device may be meeting a performance goal or exceeding his or her past performances with or without relation to a specific performance goal, and may be a message, such as “Push yourself a bit more. You're almost there,” when the user of the electronic training device is not meeting a performance goal.

The various embodiments may be applicable to any location related experiences in which a user may wish to pace travel. For example, a hybrid car driver may use the various embodiments to compare his or her gas efficiency against past gas efficiencies in the same location and/or over the same route. As additional examples, the various embodiments may be applicable to activities including, running, bicycling, walking, horseback riding, motor sport racing, swimming, sailing, driving, hiking, rock climbing, etc.

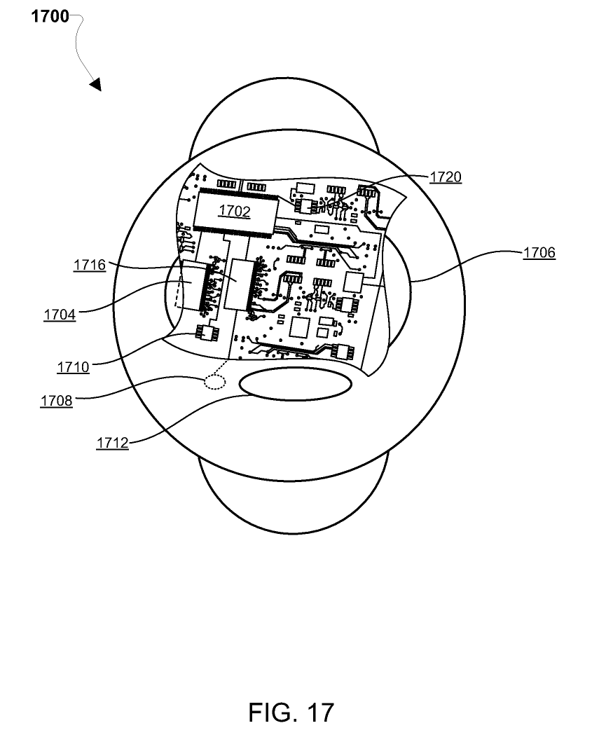

The various embodiments may be implemented in any of a variety of electronic training devices, such as a sports watch, an example of which is illustrated in FIG. 17. For example, the sports watch 1700 may include a processor 1702 coupled to internal memories 1704 and 1710. Internal memories 1704 and 1710 may be volatile or non-volatile memories, and may also be secure and/or encrypted memories, or unsecure and/or unencrypted memories, or any combination thereof. The processor 1702 may also be coupled to a touch screen display 1706, such as a resistive-sensing touch screen, capacitive-sensing touch screen infrared sensing touch screen, or the like. Additionally, the display of the sports watch 1700 need not have touch screen capability. Additionally, the sports watch 1700 may have one or more antenna 1708 for sending and receiving electromagnetic radiation that may be connected to a wireless data link and/or cellular telephone transceiver 1716 coupled to the processor 1702. The sports watch 1700 may also include a physical buttons 1712 for receiving user inputs. The sports watch 1700 may also include a position sensor 1720, such as a GPS receiver, coupled to the processor 1702.

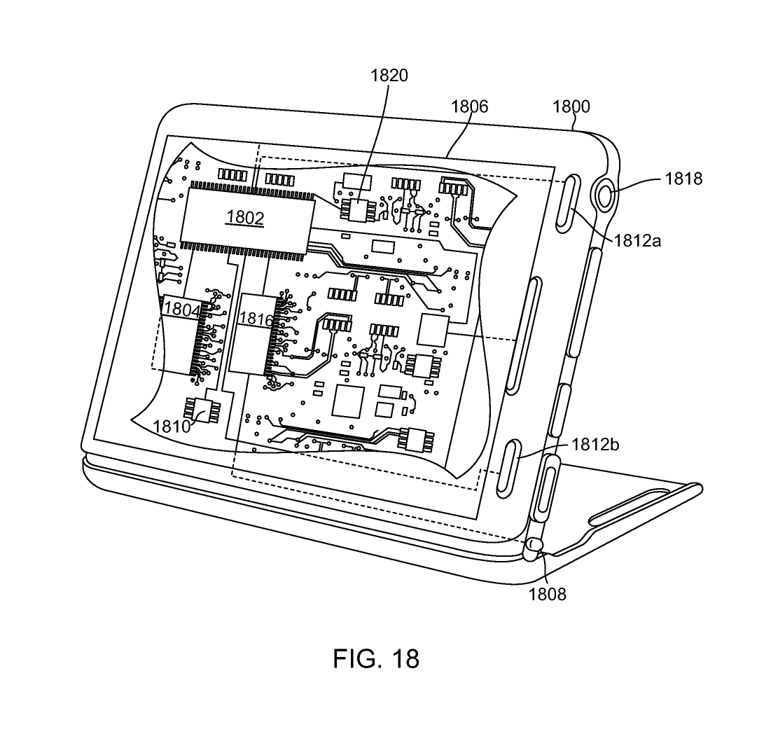

The various embodiments described above may also be implemented in any of a variety of mobile devices, an example of which is illustrated in FIG. 18. For example, the mobile device 1800 may include a processor 1802 coupled to internal memories 1804 and 1810. Internal memories 1804 and 1810 may be volatile or non-volatile memories, and may also be secure and/or encrypted memories, or unsecure and/or unencrypted memories, or any combination thereof. The processor 1802 may also be coupled to a touch screen display 1806, such as a resistive-sensing touch screen, capacitive-sensing touch screen infrared sensing touch screen, or the like. Additionally, the display of the mobile device 1800 need not have touch screen capability. Additionally, the mobile device 1800 may have one or more antenna 1808 for sending and receiving electromagnetic radiation that may be connected to a wireless data link and/or cellular telephone transceiver 1816 coupled to the processor 1802. The mobile device 1800 may also include physical buttons 1812a and 1812b for receiving user inputs. The mobile device 1800 may also include a power button 1818 for turning the mobile device 1800 on and off. The mobile device 1800 may also include a position sensor 1820, such as a GPS receiver, coupled to the processor 1802.

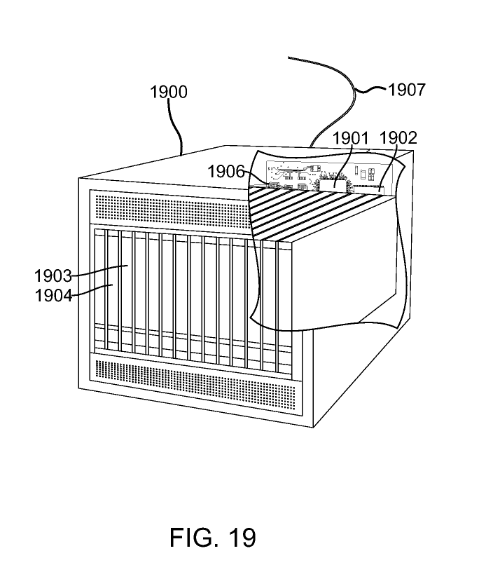

The various embodiments may also be implemented on any of a variety of commercially available server devices, such as the server 1900 illustrated in FIG. 19. Such a server 1900 typically includes a processor 1901 coupled to volatile memory 1902 and a large capacity nonvolatile memory, such as a disk drive 1903. The server 1900 may also include a floppy disc drive, compact disc (CD) or DVD disc drive 1904 coupled to the processor 1901. The server 1900 may also include network access ports 1906 coupled to the processor 1901 for establishing network interface connections with a network 1907, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 1702, 1802, and 1901 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 1704, 1710, 1804, 1810, 1902, 1903 before they are accessed and loaded into the processors 1702, 1802, and 1901. The processors 1702, 1802, and 1901 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1702, 1802, and 1901 including internal memory or removable memory plugged into the device and memory within the processors 1702, 1802, and 1901 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory server-readable medium or non-transitory processor-readable medium. The steps of a method or algorithm disclosed herein may be embodied in a processor-executable software module which may reside on a non-transitory computer-readable or processor-readable storage medium. Non-transitory server-readable or processor-readable storage media may be any storage media that may be accessed by a computer or a processor. By way of example but not limitation, such non-transitory server-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory server-readable and processor-readable media. Additionally, the operations of a method or algorithm may reside as one or any combination or set of codes and/or instructions on a non-transitory processor-readable medium and/or server-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for supporting athletic training, comprising:
receiving, in a server, in real-time a series of positions of an electronic training device;
comparing, in the server, the series of positions to a database of training segments to identify a training segment including at least a portion of the series of positions; and
transmitting to the electronic training device training information related to the identified training segment for display by the electronic training device.

2. The method of claim 1, further comprising:
identifying, in the server, a string of segments from a current location of the electronic training device having distance and grade characteristics similar to a training route of a user of the electronic training device; and
transmitting to the electronic training device training information related to the string of segments for display on the electronic training device.

3. The method of claim 2, wherein the training information related to the string of segments includes a navigation indication identifying a direction of the string of segments.

4. The method of claim 2, wherein the training information related to the string of segments includes information related to a performance of another individual on a next segment in the string of segments.

5. The method of claim 4, wherein the information related to the performance of the other individual is real-time performance information of the other individual.

6. The method of claim 2, further comprising recognizing, in the server, when a new current location of the electronic training device does not correspond to the string of segments, and in response:
identifying, in the server, a new string of segments from the new current location of the electronic training device having distance and grade characteristics similar to another training route of the user of the electronic training device; and
transmitting to the electronic training device training information related to the new string of segments for display on the electronic training device.

7. The method of claim 6, wherein the training information related to the new string of segments includes a new navigation indication identifying a direction of the new string of segments.

8. The method of claim 1, further comprising:
identifying, in the server, a string of segments from a current location of the electronic training device having distance and grade characteristics similar to a training route of another individual sharing a common attribute with a user of the electronic training device; and
transmitting to the electronic training device training information related to the string of segments for display on the electronic training device.

9. The method of claim 8, wherein the training information related to the string of segments includes a navigation indication identifying a direction of the string of segments.

10. The method of claim 1, further comprising:
storing the series of positions of the electronic training device in the database of training segments regardless of a result of the comparison of the series of positions to the database of training segments to create a newly updated database of training segments;
receiving, in the server, in real-time a new series of positions of an electronic training device;
comparing, in the server, the new series of positions to the newly updated database of training segments to identify a new training segment including at least a portion of the new series of positions; and
transmitting to the electronic training device training information related to the identified new training segment for display by the electronic training device.

11. A server for supporting athletic training, comprising:
a memory; and
a processor, wherein the processor is configured with processor-executable instructions to perform operations comprising:
receiving in real-time a series of positions of an electronic training device;
comparing the series of positions to a database of training segments to identify a training segment including at least a portion of the series of positions; and
transmitting to the electronic training device training information related to the identified training segment for display by the electronic training device.

12. The server of claim 11, wherein the processor is configured with processor-executable instructions to perform operations further comprising:
identifying a string of segments from a current location of the electronic training device having distance and grade characteristics similar to a training route of a user of the electronic training device; and
transmitting to the electronic training device training information related to the string of segments for display on the electronic training device.

13. The server of claim 12, wherein the processor is configured with processor-executable instructions to perform operations such that the training information related to the string of segments includes a navigation indication identifying a direction of the string of segments.

14. The server of claim 12, wherein the processor is configured with processor-executable instructions to perform operations such that the training information related to the string of segments includes information related to a performance of another individual on a next segment in the string of segments.

15. The server of claim 14, wherein the processor is configured with processor-executable instructions to perform operations such that the information related to the performance of the other individual is real-time performance information of the other individual.

16. The server of claim 12, wherein the processor is configured with processor-executable instructions to perform operations further comprising recognizing when a new current location of the electronic training device does not correspond to the string of segments, and in response:
identifying a new string of segments from the new current location of the electronic training device having distance and grade characteristics similar to another training route of the user of the electronic training device; and
transmitting to the electronic training device training information related to the new string of segments for display on the electronic training device.

17. The server of claim 16, wherein the processor is configured with processor-executable instructions to perform operations such that the training information related to the new string of segments includes a new navigation indication identifying a direction of the new string of segments.

18. The server of claim 11, wherein the processor is configured with processor-executable instructions to perform operations further comprising:
identifying a string of segments from a current location of the electronic training device having distance and grade characteristics similar to a training route of another individual sharing a common attribute with a user of the electronic training device; and
transmitting to the electronic training device training information related to the string of segments for display on the electronic training device.

19. The server of claim 18, wherein the processor is configured with processor-executable instructions to perform operations such that the training information related to the string of segments includes a navigation indication identifying a direction of the string of segments.

20. The server of claim 11, wherein the processor is configured with processor-executable instructions to perform operations further comprising:
storing the series of positions of the electronic training device in the database of training segments regardless of a result of the comparison of the series of positions to the database of training segments to create a newly updated database of training segments;
receiving in real-time a new series of positions of an electronic training device;
comparing the new series of positions to the newly updated database of training segments to identify a new training segment including at least a portion of the new series of positions; and
transmitting to the electronic training device training information related to the identified new training segment for display by the electronic training device.

21. A server for supporting athletic training, comprising:
means for receiving in real-time a series of positions of an electronic training device;
means for comparing the series of positions to a database of training segments to identify a training segment including at least a portion of the series of positions; and
means for transmitting to the electronic training device training information related to the identified training segment for display by the electronic training device.

22. The server of claim 21, further comprising:
means for identifying a string of segments from a current location of the electronic training device having distance and grade characteristics similar to a training route of a user of the electronic training device; and
means for transmitting to the electronic training device training information related to the string of segments for display on the electronic training device.

23. The server of claim 22, wherein the training information related to the string of segments includes a navigation indication identifying a direction of the string of segments.

24. The server of claim 22, wherein the training information related to the string of segments includes information related to a performance of another individual on a next segment in the string of segments.

25. The server of claim 24, wherein the information related to the performance of the other individual is real-time performance information of the other individual.

26. The server of claim 22, further comprising means for recognizing when a new current location of the electronic training device does not correspond to the string of segments, and in response:
means for identifying a new string of segments from the new current location of the electronic training device having distance and grade characteristics similar to another training route of the user of the electronic training device; and
means for transmitting to the electronic training device training information related to the new string of segments for display on the electronic training device.

27. The server of claim 26, wherein the training information related to the new string of segments includes a new navigation indication identifying a direction of the new string of segments.

28. The server of claim 21, further comprising:
means for identifying a string of segments from a current location of the electronic training device having distance and grade characteristics similar to a training route of another individual sharing a common attribute with a user of the electronic training device; and
means for transmitting to the electronic training device training information related to the string of segments for display on the electronic training device.

29. The server of claim 28, wherein the training information related to the string of segments includes a navigation indication identifying a direction of the string of segments.

30. The server of claim 21, further comprising:
means for storing the series of positions of the electronic training device in the database of training segments regardless of a result of the comparison of the series of positions to the database of training segments to create a newly updated database of training segments;
means for receiving in real-time a new series of positions of an electronic training device;
means for comparing the new series of positions to the newly updated database of training segments to identify a new training segment including at least a portion of the new series of positions; and
means for transmitting to the electronic training device training information related to the identified new training segment for display by the electronic training device.

31. A non-transitory server-readable storage medium having stored thereon processor-executable instructions configured to cause a server to perform operations comprising:
receiving in real-time a series of positions of an electronic training device;
comparing the series of positions to a database of training segments to identify a training segment including at least a portion of the series of positions; and
transmitting to the electronic training device training information related to the identified training segment for display by the electronic training device.

32. The non-transitory server-readable storage medium of claim 31, wherein the stored processor-executable instructions are configured to cause a server to perform operations further comprising:
identifying a string of segments from a current location of the electronic training device having distance and grade characteristics similar to a training route of a user of the electronic training device; and
transmitting to the electronic training device training information related to the string of segments for display on the electronic training device.

33. The non-transitory server-readable storage medium of claim 32, wherein the stored processor-executable instructions are configured to cause a server to perform operations such that the training information related to the string of segments includes a navigation indication identifying a direction of the string of segments.

34. The non-transitory server-readable storage medium of claim 32, wherein the stored processor-executable instructions are configured to cause a server to perform operations such that the training information related to the string of segments includes information related to a performance of another individual on a next segment in the string of segments.

35. The non-transitory server-readable storage medium of claim 34, wherein the stored processor-executable instructions are configured to cause a server to perform operations such that the information related to the performance of the other individual is real-time performance information of the other individual.

36. The non-transitory server-readable storage medium of claim 32, wherein the stored processor-executable instructions are configured to cause a server to perform operations further comprising recognizing when a new current location of the electronic training device does not correspond to the string of segments, and in response:
identifying a new string of segments from the new current location of the electronic training device having distance and grade characteristics similar to another training route of the user of the electronic training device; and
transmitting to the electronic training device training information related to the new string of segments for display on the electronic training device.

37. The non-transitory server-readable storage medium of claim 36, wherein the stored processor-executable instructions are configured to cause a server to perform operations such that the training information related to the new string of segments includes a new navigation indication identifying a direction of the new string of segments.

38. The non-transitory server-readable storage medium of claim 31, wherein the stored processor-executable instructions are configured to cause a server to perform operations further comprising:
identifying a string of segments from a current location of the electronic training device having distance and grade characteristics similar to a training route of another individual sharing a common attribute with a user of the electronic training device; and
transmitting to the electronic training device training information related to the string of segments for display on the electronic training device.

39. The non-transitory server-readable storage medium of claim 38, wherein the stored processor-executable instructions are configured to cause a server to perform operations such that the training information related to the string of segments includes a navigation indication identifying a direction of the string of segments.

40. The non-transitory server-readable storage medium of claim 31, wherein the stored processor-executable instructions are configured to cause a server to perform operations further comprising:
storing the series of positions of the electronic training device in the database of training segments regardless of a result of the comparison of the series of positions to the database of training segments to create a newly updated database of training segments;
receiving in real-time a new series of positions of an electronic training device;
comparing the new series of positions to the newly updated database of training segments to identify a new training segment including at least a portion of the new series of positions; and
transmitting to the electronic training device training information related to the identified new training segment for display by the electronic training device.

41. A system for supporting athletic training, comprising:
an electronic training device, comprising:
an electronic training device memory;
a position sensor;
a display; and
an electronic training device processor connected to the electronic training device memory and location sensor; and
a server, comprising:
a server memory; and
a server processor connected to the server memory,
wherein the electronic training device processor is configured with processor-executable instructions to perform operations comprising:
obtaining in real-time a series of positions of the electronic training device from the position sensor; and
transmitting the series of positions of the electronic training device to the server,
wherein the server processor is configured with processor-executable instructions to perform operations comprising:
receiving the series of positions of the electronic training device;
comparing the series of positions to a database of training segments to identify a training segment including at least a portion of the series of positions; and
transmitting to the electronic training device training information related to the identified training segment, and
wherein the electronic training device processor is configured with processor-executable instructions to perform operations further comprising:
receiving the information related to the identified training segment; and
displaying the information related to the identified training segment on the display.

42. A system for supporting athletic training, comprising:
an electronic training device; and
a server,
wherein the electronic training device comprises:
means for obtaining in real-time a series of positions of the electronic training device; and
means for transmitting the series of positions of the electronic training device to a server,
wherein the server comprises
means for receiving the series of positions of the electronic training device;
means for comparing the series of positions to a database of training segments to identify a training segment including at least a portion of the series of positions; and
means for transmitting to the electronic training device training information related to the identified training segment, and
wherein the electronic training device further comprises:
means for receiving the information related to the identified training segment; and
means for displaying the information related to the identified training segment.

43. An electronic training device for supporting athletic training, comprising:
means for obtaining in real-time a series of positions of the electronic training device;
means for comparing the series of positions to a database of training segments to identify a training segment including at least a portion of the series of positions; and
means for displaying training information related to the identified training segment.

44. A electronic training device for supporting athletic training, comprising:
a memory
a position sensor;
a display; and
a processor connected to the memory, position sensor, and display, wherein the processor is configured with processor-executable instructions to perform operations comprising:
obtaining in real-time a series of positions of the electronic training device from the position sensor;
comparing the series of positions to a database of training segments to identify a training segment including at least a portion of the series of positions; and
displaying training information related to the identified training segment on the display.

45. A non-transitory processor-readable storage medium having stored thereon processor-executable instructions configured to cause a processor of an electronic training device to perform operations comprising:
obtaining in real-time a series of positions of the electronic training device;
comparing the series of positions to a database of training segments to identify a training segment including at least a portion of the series of positions; and
displaying training information related to the identified training segment.
